(19) United States
(12) Patent Application Publication
(10) Pub. No.: US 2015/0051862 A1
(43) Pub. Date: Feb. 19, 2015

(54) METHOD AND APPARATUS FOR INSPECTING WORKPIECES

(71) Applicant: RENISHAW PLC, Wotton-under-Edge, Gloucestershire (GB)

(72) Inventor: Kevyn Barry Jonas, Clevedon (GB)

(21) Appl. No.: 14/386,587

(22) PCT Filed: Mar. 21, 2013
(86) PCT No.: PCT/GB2013/000125

§ 371 Date: Sep. 19, 2014

(30) Foreign Application Priority Data
Mar. 21, 2012 (GB) 1204947.4

(51) Int. Cl. G01B 21/04

(52) U.S. Cl. CPC G01B 21/045
USPC 702/97

(57) ABSTRACT

Methods are described for measuring series of nominally identical production workpieces on a dimensional measuring apparatus such as a coordinate measuring machine. One master workpiece of the series is calibrated, to provide correction values which are used to build an error map of the measuring apparatus. This map is used to correct measurements not only of subsequent nominally identical workpieces of the same series, but also of multiple different subsequent series of different workpieces. Each subsequent series also has a master workpiece which is calibrated and used to further build the error map. As this process is repeated over time, the error map becomes more and more densely populated. In due course, it becomes possible to dispense with the use of a calibrated master workpiece, because measurements can be corrected using error values which already exist in the error map.

### FIELD OF THE INVENTION

This invention relates to coordinate measuring apparatus for inspecting the dimensions of workpieces. Coordinate measuring apparatus include, for example, coordinate measuring machines (CMM), machine tools, manual coordinate measuring arms and inspection robots.

### DESCRIPTION OF PRIOR ART

After workpieces have been produced, it is known to inspect them on a coordinate measuring machine (CMM) having a movable member supporting a probe, which can be driven within a three-dimensional working volume of the machine.

The CMM (or other coordinate measuring apparatus) may be a so-called Cartesian machine, in which the movable member supporting the probe is mounted via three serially-connected carriages which are respectively movable in three orthogonal directions X,Y,Z. Alternatively, it may be a non-Cartesian machine, for example comprising three or six extensible struts which are each connected in parallel between the movable member and a relatively fixed base member or frame. The movement of the movable member (and thus the probe) in the X,Y,Z working volume is then controlled by coordinating the respective extensions of the three or six struts. An example of a non-Cartesian machine is shown in International Patent Applications WO 03/006837 and WO 2004/063579.

It is known to calibrate such coordinate measuring apparatus by producing a map of the measurement errors experienced throughout its X,Y,Z working volume. For example, U.S. Pat. No. 4,819,195 (Bell et al) describes the use of calibration equipment such as laser interferometers, electronic levels, etc. in order to produce a map of static errors (i.e. errors which occur even when the apparatus is not moving). This map gives correction values for 21 different sources of static error, for every point in a grid spread over the X,Y,Z working volume.

A less accurate alternative is to use a calibration fixture which comprises a “forest” of multiple balls. These balls are accurately spherical, have accurately known dimensions, and they are mounted in the fixture so as to be spaced in three dimensions with accurately known relationships to each other. The fixture is placed in the working volume of the coordinate measuring apparatus and the balls are measured using the apparatus to move the probe. By comparison with the known dimensions and spacings of the balls, this produces a coarse map of the measurement errors experienced at a grid of points spread over the X,Y,Z working volume. Other calibration artefacts may be used instead of balls, e.g. ring gauges. However, if high accuracy is required, this technique would require the use of a very large number of balls, say 10,000, which is not practical.

Such error maps may take the form of a lookup table of correction values to be applied to measurements at respective points in the grid spread over the X,Y,Z working volume. Optionally, polynomial error functions can be fitted to the errors at these points to determine errors at other points.

U.S. Pat. Nos. 5,594,668 and 5,895,442 (assigned to Zeiss) produce maps of dynamic errors occurring throughout the X,Y,Z working volume. Dynamic errors occur as a result of bending of various parts of the apparatus or the probe during accelerating movements.

Error maps such as described above are used during subsequent measurements of workpieces. The X,Y,Z coordinate measurements taken by the apparatus are corrected, using the corresponding static and/or dynamic errors recorded in the error map for the X,Y,Z position concerned. Or in the case of an error function, the required correction is determined from the value of the function for the X,Y,Z position concerned.

U.S. Pat. No. 7,079,969 (assigned to Renishaw) corrects for static and dynamic errors without the need for a complete map of such errors over the entire X,Y,Z working volume of the apparatus. A calibrated artefact is nominally identical to workpieces to be measured. It is measured on the coordinate measuring apparatus, at a desired fast speed. The measurements obtained are compared with the dimensions known from the calibration of the artefact. This is used to generate an error map of the static and dynamic errors experienced during the measurement of the artefact. This error map is then used to correct measurements taken subsequently on nominally identical workpieces at the same fast speed.

One advantage of the technique described in U.S. Pat. No. 7,079,969 is that the error map is specific to measurements actually taken on the artefact and the nominally identical workpieces. It is not necessary to map the errors over the entire X,Y,Z volume of the coordinate measuring apparatus. However, as a corollary, further calibration is required if the apparatus is to be used to take accurate measurements on workpieces which have different shapes, and/or which are located in different parts of the working volume of the apparatus, and/or at different measurement speeds. Either the procedure described in U.S. Pat. No. 7,079,969 must be repeated every time new workpieces are to be measured, or a static and/or dynamic error map of the entire machine must be produced.

Our co-pending International Patent Application No. WO 2013/021157 describes methods and apparatus in which one or more error maps, lookup tables or functions are produced, with reference to the temperature of the measurement. Preferably this is done for measurements at two or more temperatures. A master artefact or reference workpiece is measured at each of the temperatures. These error maps, lookup tables or functions are specific to measurements actually taken on the master artefact or reference workpiece, and subsequent nominally identical workpieces.

### SUMMARY OF THE INVENTION

One aspect of the present invention provides a method for measuring production workpieces on a dimensional measuring apparatus, comprising:
taking a production workpiece which is one of a first series of nominally identical workpieces produced by a production process;
measuring the production workpiece on the measuring apparatus;
obtaining calibration values for the production workpiece, from a source external to said measuring apparatus;
comparing the calibration values with the measurement of the workpiece, to produce one or more correction values;
using said correction values to populate or repopulate an error map or lookup table or to calculate or recalculate an error function, for calibrating the measuring apparatus;
measuring one or more further nominally identical workpieces of the first series produced by the production process on the measuring apparatus;
correcting the measurements of the further nominally identical workpieces of the first series using said correction values or the error map or lookup table or error function;
characterised by measuring one or more second workpieces on the measuring apparatus, wherein the second workpiece or workpieces are different from, or are differently located on the apparatus from, the nominally identical workpieces of said first series of workpieces; and
correcting the measurements of the one or more second workpieces using said error map or lookup table or error function.

The production workpieces of the first series may be intended for incorporation into a manufactured product. In an alternative aspect of the invention, an artefact which has features which approximate or match such production workpieces may be used instead of the first-mentioned production workpiece. These features may approximate or match corresponding features of the production workpiece. The correction values and/or calibration values may relate to the features which approximate or match the production workpiece.

Since it relates to a specific series of such workpieces, such an artefact is to be distinguished from standard, general purpose calibration artefacts (such as a calibrated spheres or ring gauges) which are known for use in the calibration of measurement apparatus such as coordinate measuring machines. Such standard calibration artefacts are specially made for general purpose calibration of measurement apparatus, not related to specific production workpieces. Generally, a production workpiece is an item the dimensions of which are to be determined by measurement on the measuring apparatus, whereas the dimensions of a standard calibration artefact are previously known in order to calibrate the apparatus.

The calibration values may be obtained from an external source by calibrating the workpiece or artefact in a separate measurement process, e.g. on a more accurate CMM, roundness measuring machine or other measuring apparatus. Alternatively, the calibration values may be determined from a CAD design file describing the production workpiece (e.g. on the assumption that it has been accurately manufactured).

The correction values may be used directly for correcting the measurements of other workpieces in the first series, or indirectly by using the error map, lookup table or error function.

The correction values may be used to create a new error map or look-up table or to calculate a new error function. Alternatively the correction values may be used to further populate an existing error map or look-up table or to recalculate an existing error function. The existing error map, lookup table or error function may have been created by a conventional calibration of the measuring apparatus, e.g. using standard calibration artefacts such as accurately calibrated balls or ring gauges. Or it may have been created by a previous iteration of the above method according to the invention.

In a preferred form of the method, the second workpiece may form part of one or more further series of workpieces, the workpieces of each series being nominally identical to other workpieces of that series, the workpieces of each series being different from, or being differently located on the apparatus from, the workpieces already measured; the method comprising, for each such different series:
measuring an artefact, the artefact being one of the nominally identical workpieces of that series, or having features the size and shape of which approximate such a workpiece of that series;
obtaining calibration values for the artefact, from a source external to said measuring apparatus;
comparing the calibration values with the measurement of the artefact, to produce one or more correction values; and
using said correction values to further populate said error map or lookup table or recalculate said error function.

In this preferred form of the method, the error map or look-up table or error function may then be used to correct the measurement of subsequent workpieces which are different from those of said first and further series of workpieces or which are differently located on the apparatus.

Preferably the measurements on the first and further series of workpieces take place at the same temperature, to within a predetermined tolerance, so that the error map, lookup table or function relates to that temperature.

A respective error map or lookup table or function may be produced for each of two or more temperatures at which measurements of the calibrated artefact take place. This permits a method wherein the temperature of the measurement of the subsequent workpiece is determined, and then the measurement is corrected using an error map, lookup table or function which corresponds to that temperature to within a predetermined tolerance. Alternatively, the temperature of the measurement of the subsequent workpiece may be determined, and then the measurement may be corrected by interpolation between or extrapolation from two or more of the error maps or lookup tables or functions.

As a further alternative, an error function may be produced which has a term relating to the variation of measurement errors with the temperature at which the measurement takes place. This permits a method wherein the temperature of the measurement of the subsequent workpiece is determined, and then the measurement is corrected using said error function taking account of the temperature.

A further aspect of the invention provides a method for calibrating a measuring apparatus, comprising:
providing an initial error map or initial lookup table or initial error function for calibrating the apparatus, the initial error map or initial lookup table being populated using correction values, or the initial error function being calculated using correction values;
measuring a calibrated workpiece on the measuring apparatus, the workpiece being one of a first series of nominally identical workpieces, or having features the size and shape of which approximate such a workpiece;
comparing the measurement of the workpiece with the calibration of the workpiece to produce one or more further correction values; and
further populating said error map or lookup table or recalculating said error function, using the further error values.

The initial error map or initial lookup table may be populated, or the initial error function may be calculated, by measuring a first calibrated artefact on the measuring apparatus; comparing the measurement of the artefact with the calibration of the artefact to produce one or more correction values; and using said correction values to populate the error map or lookup table or to calculate the error function. The first artefact may be a standard calibration artefact, such as for example a ball or ring gauge, or a fixture comprising a plurality of balls or ring gauges. Such a standard calibration artefact is to be distinguished from a workpiece as discussed above.

Alternatively, the initial error map or initial lookup table may be populated, or the initial error function may be calculated by any known calibration process, e.g. using calibration equipment such as laser interferometers, electronic levels, etc.

Preferably the one or more further correction values are used to correct measurements of other workpieces in the first series. Additionally or alternatively, the error map or look-up table or error function may be used to correct the measurement of subsequent workpieces which are different from those of said first series of workpieces or which are differently located on the apparatus.

In a preferred method, the initial error map or initial lookup table or initial error function relates to errors in measurements taken at a particular temperature, and the measurements on the calibrated workpiece take place at the same temperature. A respective error map or lookup table or function may be produced for each of two or more temperatures.

The temperature of the measurement of a subsequent workpiece may be determined, and then the measurement may be corrected using an error map, lookup table or function corresponding to that temperature. Alternatively, the temperature of the measurement of a subsequent workpiece may be determined, and then the measurement may be corrected by interpolation between or extrapolation from two or more of the error maps or lookup tables or functions.

Preferably, over time, in any aspect of the invention, the apparatus is used to measure further series of workpieces, which are different again (or differently located on the apparatus) from those already measured. This may be part of the normal use of the apparatus by the user to measure production workpieces. For each such different series, a workpiece is calibrated, which may be one of the workpieces of the series, or may have features the size and shape of which approximate such a workpiece. This workpiece is then measured on the measuring apparatus and further error values for the different series are obtained and used to further populate the error map or lookup table, or further recalculate the error function.

As this process is repeated over time, the error map or lookup table becomes more and more densely populated, or the error function is based on more and more values. In due course, when a further different workpiece or series of workpieces is to be measured, it will be possible to dispense with the use of a calibrated workpiece, because measurements can be corrected using error values which already exist in the error map or lookup table, or using the existing error function.

In any aspect of the invention, the measuring apparatus may be a coordinate measuring apparatus, such as a coordinate measuring machine. It may be a non-Cartesian coordinate measuring apparatus.

The calibrated workpiece and/or the calibrated artefact may be calibrated by measuring it on a separate, more accurate coordinate measuring machine or other measuring apparatus.

The workpiece measurements may include coordinate measurements of individual points on the surface of the workpiece. And/or the workpiece measurements may include measurements of dimensions of features of the workpiece. These may be derived from such coordinate measurements of points.

In any aspect of the invention, where the temperature of a measurement is determined, this may be determined from the temperature of the environment in which the measurement is made, or from the temperature of the apparatus or of the workpiece being measured. The temperature may be measured directly or indirectly.

Further aspects of the invention include measuring apparatus configured to perform any of the above methods, and programs for a computer control of a measuring apparatus, which configure the apparatus to perform any such method. The invention also encompasses a computer-readable medium having computer-executable instructions for causing a computer to perform any such method. More specifically, such a computer-readable medium may be a non-transitory computer-readable medium (or a non-transitory processor-readable medium) having computer-executable instructions or computer code thereon for performing various computer-implemented operations as described herein. The non-transitory computer-readable medium (or processor-readable medium) is non-transitory in the sense that it does not include transitory propagating signals such as a propagating electromagnetic wave carrying information on a transmission medium.

### BRIEF DESCRIPTION OF THE DRAWINGS

Preferred embodiments of the invention will now be described, by way of example, with reference to the accompanying drawings, wherein:

FIG. 1 is a diagrammatic representation of a non-Cartesian coordinate measuring machine (CMM);

FIG. 2 shows diagrammatically a part of a computer control system of the machine; and

FIGS. 3-6 are flowcharts of methods of using the CMM.

### DESCRIPTION OF PREFERRED EMBODIMENTS

Measurement Apparatus

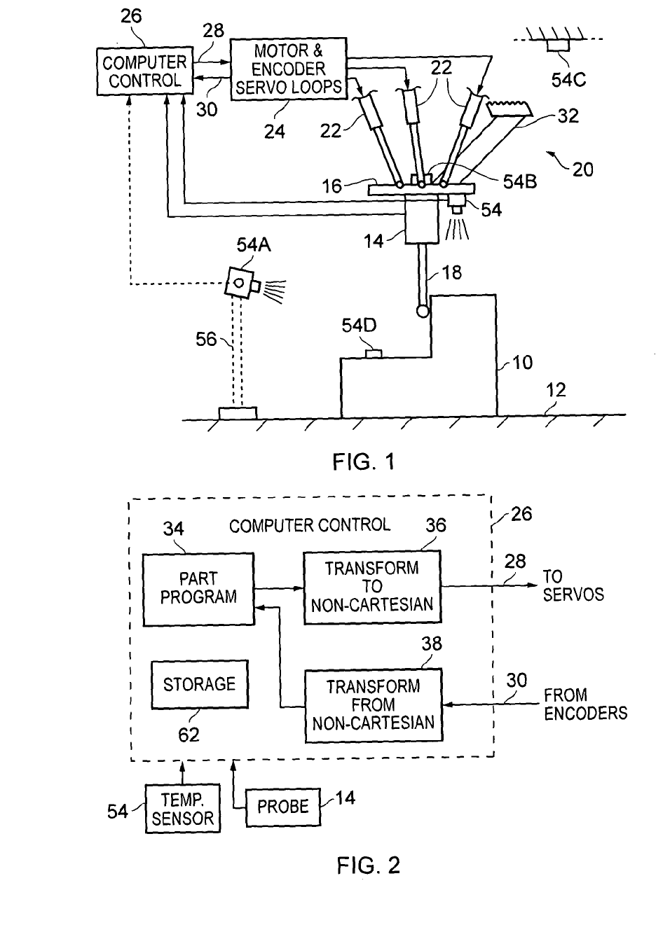

In the coordinate measuring machine shown in FIG. 1, a workpiece 10 which is to be measured is placed on a table 12 (which forms part of the fixed structure of the machine). A probe having a body 14 is mounted to a movable platform member 16. The probe has a displaceable elongate stylus 18, which in use is brought into contact with the workpiece 10 in order to make dimensional measurements.

The movable platform member 16 is mounted to the fixed structure of the machine by a supporting mechanism 20, only part of which is shown. In the present example, the supporting mechanism 20 is as described in International Patent Applications WO 03/006837 and WO 2004/063579. It comprises three telescopic extensible struts 22, extending in parallel between the platform 16 and the fixed structure of the machine. Each end of each strut 22 is universally pivotably connected to the platform 16 or to the fixed structure respectively, and is extended and retracted by a respective motor. The amount of the extension is measured by a respective encoder. The motor and encoder for each strut 22 form part of a servo loop controlling the extension and retraction of the strut. In FIG. 1, the three motors and encoders in their three respective servo loops are indicated generally by reference numeral 24.

The supporting mechanism 20 also comprises three passive anti-rotation devices 32 (only one of which is shown in FIG. 1). The anti-rotation devices extend in parallel between the platform 16 and the fixed structure of the machine. Each anti-rotation device constrains the platform 16 against one rotational degree of freedom. As a result, the platform 16 is movable with only three translational degrees of freedom, but cannot tilt or rotate. See U.S. Pat. No. 6,336,375 for further discussion of such anti-rotation devices.

Referring to FIG. 1 with FIG. 2, a computer control 26 positions the movable platform 16, under the control of a part program 34 which has been written for the measurement of the workpiece 10. To achieve this, the control 26 coordinates the respective extensions of the three struts 22. A program routine 36 transforms commands in X,Y,Z Cartesian coordinates from the part program to corresponding non-Cartesian lengths required of the struts. It produces demand signals 28 to each of the servo loops 24, as a result of which the three struts 22 extend or retract to position the platform 16 accordingly. Each servo loop acts in a known manner to drive the respective motor so as to cause the encoder output to follow the demand signal 28, tending to equalise them.

The control 26 also receives measurement signals 30 from the encoders which form part of the servo loops. These indicate the instantaneous non-Cartesian lengths of each of the struts 22. They are transformed back into Cartesian X,Y,Z coordinates by a program routine 38, for use by the part program 34.

The probe 14 may be a touch trigger probe, which issues a trigger signal to the computer control 26 when the stylus 18 contacts the workpiece 10. Alternatively, it may be a so-called measuring or analogue probe, providing analogue or digital outputs to the control 26, which measure the displacement of the stylus 18 relative to the body 14 of the probe in three orthogonal directions X, Y, Z. Instead of such contact probes, it may be a non-contact probe such as an optical probe.

In use, the platform 16 is moved to position the probe 14 relative to the workpiece 10, under the control of the part program, either in a point-to-point measurement pattern, or scanning the surface of the workpiece. For touch trigger measurements, when it receives the touch trigger signal the computer control 26 takes instantaneous readings of the non-Cartesian measurement signals 30 from the encoders of the struts 22, and the transform routine 38 processes these to determine an X,Y,Z Cartesian coordinate position of the point contacted on the workpiece surface. In the case of a measuring or analogue probe, the control combines the instantaneous outputs of the probe with the instantaneous values transformed into Cartesian coordinates from the measurement signals 30 of the struts. In the case of scanning, this is done at a large number of points to determine the form of the workpiece surface. If required, feedback from a measuring or analogue probe may be used to alter the demand signals 28, so that the machine moves the probe in order to keep it within a desired measuring range of the workpiece surface.

Making and Correcting Measurements

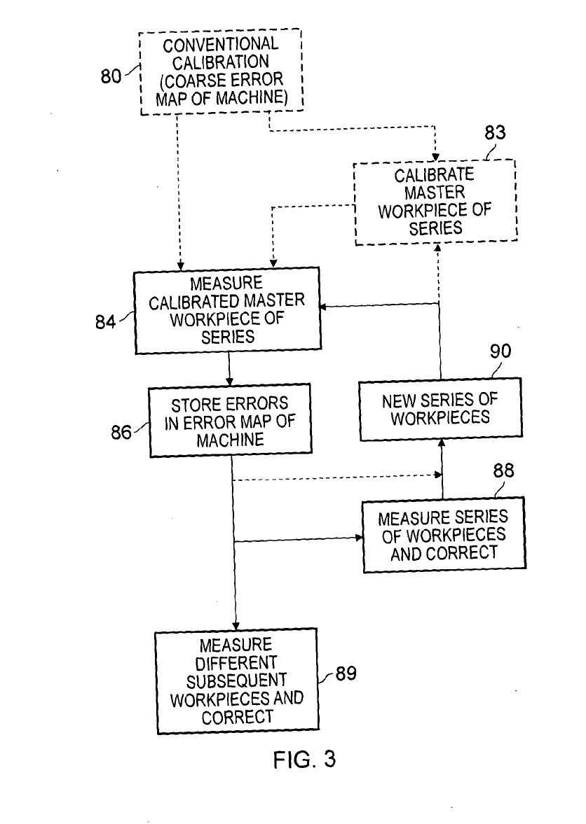

In use, the apparatus described may be used to inspect a series of workpieces which are nominally or substantially identical, e.g. as they come off a production line, or as they are manufactured on a machine tool. It may also be used to inspect multiple such series, each series having workpieces different from the preceding series, and/or which are the same as a preceding series but located at a different position or orientation on the apparatus. To do this, the computer control 26 may operate a program as shown in FIG. 3.

In an optional step 80 at the outset, the apparatus may be pre-calibrated conventionally, to produce a coarse initial error map. Any known calibration method may be used, e.g. before the apparatus leaves the manufacturer's factory, or when it is initially installed at the user's premises. Examples are shown in U.S. Pat. No. 4,919,195 (Bell et al), such as using laser interferometers and/or electronic levels. For example, as described in the introduction, a calibration fixture may be used which comprises a “forest” of multiple balls. These balls are accurately spherical, have accurately known dimensions, and they are spaced in three dimensions with accurately known relationships to each other. The fixture is placed in the working volume of the coordinate measuring apparatus and the balls are measured using the apparatus to move the probe. By comparison with the known dimensions and spacings of the balls, this produces a coarse map of the measurement errors experienced at a grid of points spread over the X,Y,Z working volume, e.g. in the form of a lookup table of correction values. Optionally, error functions such as polynomial error functions can be fitted to the errors at these points to determine errors at other points. Other calibration artefacts may be used instead of balls, e.g. ring gauges.

The coarse error map or lookup table thus produced is stored in the storage 62 of the computer control. It is stored in a sparse array, in which many values are not yet populated. With this coarse error map, the apparatus is already useful for making working measurements on workpieces. For example, if the map has error values for points spaced by 2mm, then comparison mathematics used by the part program 34 may correct measurement values to an accuracy of, say, 200 μm. If the map has error values for points spaced by 80 μm, then the comparison mathematics may correct measurement values to an accuracy of, say, 5 μm.

This comparison mathematics suitably uses an error function which is fitted through the error values which are available in order to provide interpolation between them or extrapolation from them. The function may be a linear or quadratic function. Or other polynomial or non-polynomial functions may be used for the interpolation, e.g. cubic or quadratic spline or logarithmic functions.

When measuring a first series of nominally or substantially identical production workpieces, as part of a normal production measurement procedure, in step 84 a calibrated master or reference workpiece having known dimensions is placed on the table 12 of the CMM. The master workpiece may be a first workpiece in the series, or it may be a specially-produced artefact which has a number of features which are similar to those of workpieces in the series of workpieces. Suitably, in a step 83, it is calibrated on a separate, more accurate CMM, or measured in some other way, so that its dimensions are known accurately. For example, depending on the workpiece, 100 points at various positions on its surface may be calibrated.

In step 84, this known master workpiece is measured on the coordinate measuring apparatus, using the probe 14, at the same points as those calibrated. In step 86, the measured values are compared with the calibrated values, and the error at each point is determined (e.g. as a correction value, suitably in the form of an offset). These errors are stored in the same array as above in the storage 62 of the control 26, to further populate the error map or look-up table or to re-calculate the error function. Thus, the initial coarse error map, look-up table or function of the measuring apparatus is improved by incorporating error values determined from the measurement of the master or reference workpiece.

In one of the novel embodiments of the present invention, this improved error map, look-up table or function may now be used (in step 89) to correct measurements of subsequent workpieces different from the preceding first series, and/or which are the same as the preceding first series but located at a different position or orientation on the apparatus.

Thus, it should be noted that the error values determined from the measurement of the master or reference workpiece of the first series of workpieces are used to improve the calibration of the apparatus as a whole, not merely for improved measurement of the specific series of workpieces to which the master workpiece belongs or relates.

In step 88 of the preferred embodiment, the master workpiece is removed and the rest of the first series of nominally identical workpieces is measured. Each workpiece in turn is placed on the table 12, in the same position as the master workpiece, and is measured with the probe at the desired points. The measured values are corrected using the errors stored in the error map or look-up table in the storage 62, or by applying the stored error function. This step 88 is optional, as shown by the broken arrow 87.

In step 90 a new series of workpieces may now be selected for measurement. As for the first series of workpieces, this new series comprises nominally or substantially identical production workpieces. However, they are different from the workpieces of the first series, and/or located at a different position or orientation on the apparatus. In this case, therefore, the subsequent workpiece which is measured in step 89 may in fact form part of a new series in step 90. It is also possible to measure separate workpieces in step 89 in addition to the new series in step 90.

The new series of workpieces selected in step 90 can be measured in the same way as the first series. A calibrated master or reference workpiece of the new series is measured on the apparatus (step 84). The master workpiece may have been calibrated on a separate more accurate measuring apparatus (step 83). The error values for this new master workpiece are again stored in the array in the storage 62 (step 86), in order to further populate the error map. Or an error function is recalculated using the further error values. And the new series of workpieces are measured and corrected using the errors stored in the error map (step 88).

Over time, as more and more different series of workpieces are measured, the error map or look-up table will become better populated. Effectively, the error map becomes a more and more accurate map of the errors at numerous points over the X,Y,Z working volume of the apparatus. This enables a subsequent workpiece (step 89) or series of workpieces (step 90) to be measured and corrected just using the existing error map, without proceeding again through the steps 83, 84 and 86 with a calibrated master workpiece of the new series. Similarly, if an error function is produced, it becomes more and more accurate over time so that it can be used to correct a subsequent workpiece without proceeding again through the steps 83, 84 and 86.

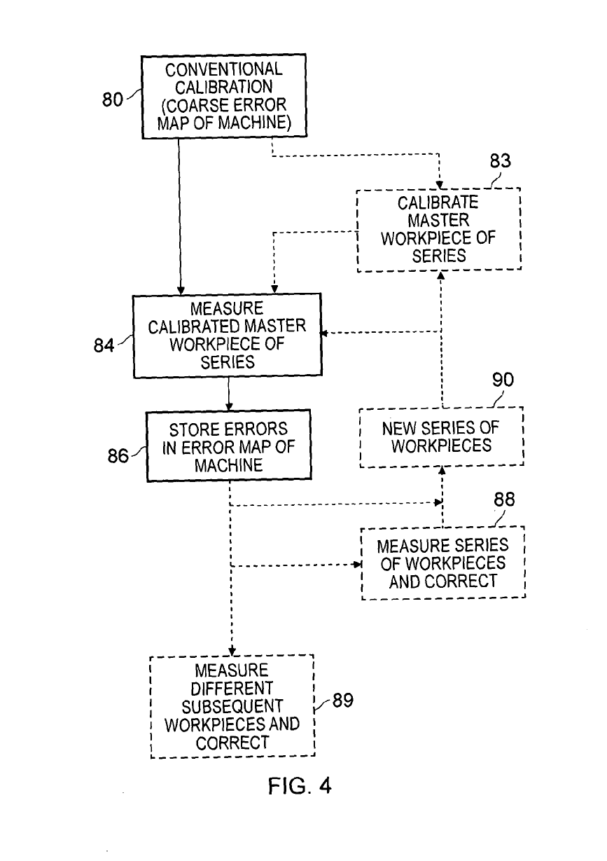

FIG. 4 shows the same steps as in FIG. 3. However, to illustrate the preferred steps of an alternative novel embodiment of the present invention, different steps have been emphasised using solid arrows instead of broken arrows. In this embodiment, the coarse initial calibration of the apparatus is undertaken (step 80) to produce an initial error map or look-up table or error function of the apparatus. This is performed in any known manner, e.g. using standard calibration artefacts, or laser interferometers, electronic levels etc.

This initial error map or look-up table or function is then improved as in steps 84 and 86 above. A master calibrated workpiece is measured (step 84). The master calibrated workpiece is one of a series of workpieces (or has a number of features which are similar to those of workpieces in the series). The errors (correction values) determined from this measurement are stored in the error map or used to re-calculate the error function. The other steps 88, 89, 90 may optionally follow as described above.

It is not necessary for all the steps of FIGS. 3 and 4 to be fully automated. For example, software running in the computer control 26 can be used to guide the user to perform the required steps.

One advantage of the method described is that it is not necessary to carry out a full calibration of the apparatus to produce an error map over its entire working volume, which is normally a time-consuming operation, perhaps taking several days. Instead, the apparatus “learns” its error map over time, during its normal day-to-day use for measuring workpieces.

It will be appreciated that, once the error map has been populated with sufficient error values, the apparatus can also be used to measure single workpieces, not merely a series for which a calibrated workpiece is available. It is used as if it had been fully calibrated in the conventional manner.

The error map which is populated as above may take the form of a lookup table, from which appropriate correction values are derived as required in order to correct measurements. The correction values value may be taken directly from the table, or they may be derived indirectly, e.g. by interpolation between or extrapolating from values in the table. Or as described above, an error function (e.g. a polynomial or non-polynomial error function) may be calculated, and recalculated as the system “learns” from the measurements of succeeding series of workpieces.

Thermal Compensation

The embodiment of the invention shown in FIG. 1 includes an infra-red temperature sensor 54, which may conveniently be mounted on the movable platform member 16 in order to address the workpiece 10 being measured and measure its temperature. Alternatively, an infra-red sensor 54A may be mounted to the fixed structure of the CMM, e.g. on an optional bracket or stand 56, in order to measure the workpiece temperature. Such an infra-red sensor may simply take an average reading of the temperature of an area of the workpiece surface, or it may be a thermal imaging sensor arranged to recognise and take the temperature of a specific workpiece feature.

In another alternative, if the CMM has facilities for automatically exchanging the probe 14, then it may be exchanged for a contact temperature sensor (not shown) which is brought into contact with the surface of the workpiece 10 and dwells there for a period in order to measure its temperature. Such an exchangeable contact temperature sensor is described in U.S. Pat. No. 5,011,297. Or a temperature sensor (such as a thermocouple) may be placed manually on the surface of the workpiece, as shown at 54D.

In a further alternative, a simple environmental temperature sensor of any suitable type (e.g. a thermocouple) may be provided in order to take the environmental temperature rather than specifically measuring the temperature of the workpiece. FIG. 1 shows such an alternative temperature sensor 54B, mounted to the platform 16 or to the probe 14. In this position it can measure the environmental temperature in the vicinity of the workpiece 10, without undue influence from heat generated by the motors. Another option is an environmental temperature sensor 54C, mounted to the fixed structure of the machine, or separately from it, so as to take the background environmental temperature.

It is possible to use two or more temperature sensors, for example one close to the workpiece such as the sensor 54 or 54B or 54D, plus another such as 54C which takes the background environmental temperature. The control 26 may then be programmed to use a weighted average of the readings from the two or more temperature sensors, e.g. 90% from the background sensor and 10% from the sensor close to the workpiece. The relative weightings may be adjusted by trial and error to obtain good results.

The temperature readings are taken to the control 26 and may be used to enable measurements to be compensated for thermal expansion and contraction as the temperature changes. This temperature compensation may for example proceed as described in our co-pending International Patent Application No. WO 2013/021157, incorporated herein by reference.

Since dimensional measurements depend on the temperature at which they are made, it is particularly advantageous that the error map or lookup table or error function should be related to a specific temperature. Thus, if the CMM is pre-calibrated with an initial error map or lookup table or function (step 80), then this should relate to a particular temperature, e.g. a standard temperature such as 20° C. All succeeding measurements which contribute to further populating the error map or lookup table or recalculating the error function should likewise be taken at that temperature, to within a predetermined tolerance. Or they should be compensated to that temperature as in the above co-pending applications, or for example using the known coefficient of thermal expansion of the workpiece material.

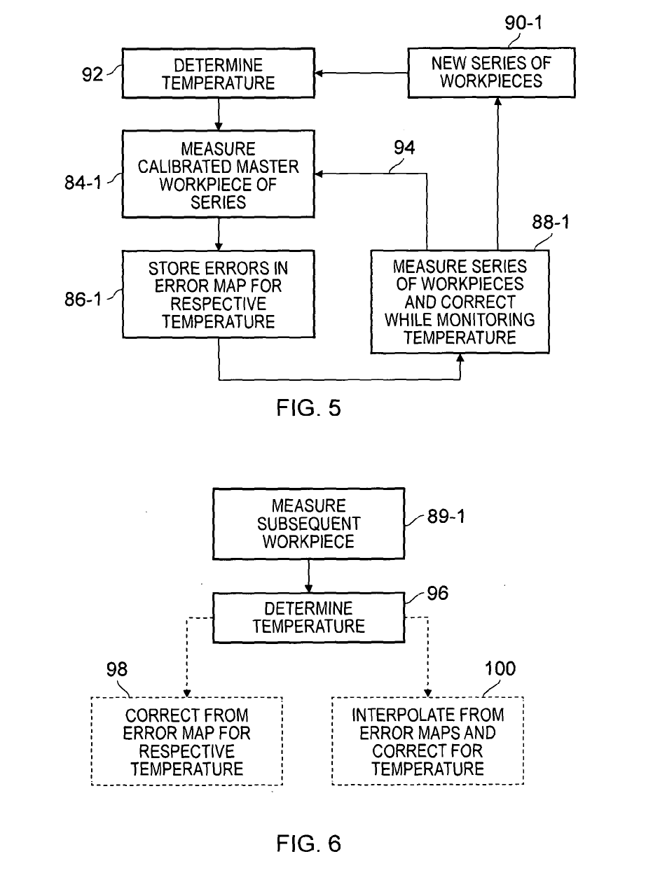

In a further preferred method according to the invention, a plurality of error maps, lookup tables or error functions are built up, each one relating to a specific temperature. This is illustrated in FIG. 5.

FIG. 5 shows steps 84-1, 86-1, 88-1 and 90-1. These correspond respectively to the steps 84, 86, 88 and 90 in FIGS. 3 and 4. They proceed in the same way as described above, except as follows, and so reference should be made to the above description for further details.

Before (or possibly after) the calibrated master workpiece is measured in step 84-1, the temperature of the measurement is also determined in a step 92, by reading one or more temperature sensors such as the sensors 54 or 54A-54D. Then, in step 86-1, the errors are stored in an error map which relates (within a predetermined tolerance) to the temperature as thus determined. (Or it may be used to calculate an error function which similarly relates to that temperature.)

Subsequent determinations to monitor the measurement temperature take place during step 88-1, as the series of workpieces is measured and corrected. If the temperature remains within the predetermined tolerance, then corrections are made from the error map, look-up table or error function for that temperature.

If it is determined that the temperature has changed by more than the predetermined tolerance, then a further iteration of the steps 84-1 and 86-1 takes place, as indicated by an arrow 94. The calibrated master workpiece is replaced on the table 12 of the machine, it is measured, and the correction values are stored in a different error map or look-up table relating (to within a predetermined tolerance) to the new temperature. Thus, a separate error map or look-up table is built up for each of a number of different measurement temperatures. Or the correction values may be used to calculate or recalculate an error function which similarly relates to that temperature.

In step 88-1, the errors are corrected using the appropriate map, table or function corresponding to the temperature at which the measurements take place.

When a new series of workpieces is to be measured, step 90-1 proceeds with a further iteration of the steps 92, 84-1, 86-1 and 88-1. The correction values produced in step 84-1 for the new master workpiece of the new series are used to build up or improve the error map or look-up table or error function which relates (to within the predetermined tolerance) to the temperature as determined in step 92. During measurements on subsequent workpieces of the new series in step 88-1, the temperature is monitored, and if it changes beyond the predetermined tolerance the master workpiece is again measured to build up or improve a different error map or table or function, relating to the changed temperature.

In the case of an error function, the above description has suggested that a separate function is built up for each temperature. However, it is instead possible to build up one error function which includes a term relating to the variation of measurement errors (over the working volume of the machine) with the temperature of the measurement. This is within the ordinary skill of a person skilled in the present field.

FIG. 6 shows possible ways in which the correction of measurements of subsequent workpieces can be performed, taking account o f the temperature of the measurement. This can be either in step 88-1, FIG. 5, or in step 89, FIGS. 3 and 4. The subsequent workpiece is measured in a step 89-1. Before or after this, the temperature of the measurement is determined (step 96), using temperature sensors such as the sensors 54 or 54A-54D. In a first option (step 98), the measurements are corrected from an error map, table or function which corresponds to the temperature thus determined, to within a predetermined tolerance.

Alternatively, if no error map, table or function corresponds with the tolerance, then in step 100 it is possible to interpolate between or extrapolate from two or more error maps, look-up tables or error functions which relate to different temperatures.

Of course, it will be appreciated that numerous modifications may be made to the above embodiments, for example as follows.

Other supporting mechanisms for moving the probe 14 can be used, rather than the supporting mechanism 20 with three extensible struts as shown in FIG. 1. For example, it is possible to use a hexapod supporting mechanism, with six extensible struts pivotably mounted in parallel between the movable member 16 and the fixed structure of the machine. Each such strut is extended and retracted by a motor and encoder forming a servo loop, as above. The extension and retraction of each strut is coordinated by the computer control, to control the movement of the movable member in five or six degrees of freedom (so the probe 14 can be orientated by tilting about X and Y axes, as well as translated in the X,Y and Z directions). The outputs of the encoders are read by the computer control and transformed into Cartesian coordinates when a measurement is to be taken.

Alternatively, the supporting mechanism for the movable member 16 and the probe 14 can be a conventional Cartesian CMM, having three serially-arranged carriages which move in X, Y and Z directions respectively.

If desired, in any of the above arrangements, the probe 14 may be mounted to the movable member 16 via a probe head, which is rotatable in one or two axes to orientate the probe. Several suitable probe heads are available from the present applicants/assignees Renishaw plc. The probe head may be of the indexing type, such as the Renishaw PH10 model, which can be locked into any of a plurality of orientations. Or it may be a continuously rotatable probe head, such as the Renishaw PH20 model. Or the probe itself may have one or two axes of continuous rotation, such as the Renishaw REVO® or PH20 probe.

1. A method for measuring production workpieces on a dimensional measuring apparatus, comprising:
taking a production workpiece which is one of a first series of nominally identical workpieces produced by a production process;
measuring the production workpiece on the measuring apparatus;
obtaining calibration values for the production workpiece, from a source external to said measuring apparatus;
comparing the calibration values with the measurement of the workpiece, to produce one or more correction values;
using said correction values to populate or repopulate an error map or lookup table or to calculate or recalculate an error function, for calibrating the measuring apparatus;
measuring one or more further nominally identical workpieces of the first series produced by the production process on the measuring apparatus;
correcting the measurements of the further nominally identical workpieces of the first series using said correction values or the error map or lookup table or error function;
measuring one or more second workpieces on the measuring apparatus, wherein the second workpiece or workpieces are different from, or are differently located on the apparatus from, the nominally identical workpieces of said first series of workpieces; and
correcting the measurements of the one or more second workpieces using said error map or lookup table or error function.

2. A method for measuring production workpieces on a dimensional measuring apparatus, comprising:
taking an artefact having a plurality of features the size and shape of which approximate a production workpiece of a first series of nominally identical workpieces produced by a production process;
measuring the artefact on the measuring apparatus;
obtaining calibration values for the artefact, from a source external to said measuring apparatus;
comparing the calibration values with the measurement of the artefact, to produce one or more correction values;
using said correction values to populate or repopulate an error map or lookup table or to calculate or recalculate an error function, for calibrating the measuring apparatus;
measuring one or more nominally identical production workpieces of the first series produced by the production process on the measuring apparatus;
correcting the measurements of the nominally identical workpieces of the first series using said correction values or the error map or lookup table or error function;
measuring one or more second workpieces on the measuring apparatus, wherein the second workpiece or workpieces are different from, or are differently located on the apparatus from, the nominally identical workpieces of said first series of workpieces; and
correcting the measurements of the one or more second workpieces using said error map or lookup table or error function.

3. A method according to claim 1, wherein the correction values are used to further populate an existing error map or look-up table or to recalculate an existing error function for calibrating the measuring apparatus.

4. A method according to claim 1, wherein the correction values are used to create a new error map or look-up table or to calculate a new error function.

5. A method according to claim 1, wherein the second workpiece forms part of one or more further series of workpieces, the workpieces of each series being nominally identical to other workpieces of that series, the workpieces of each series being different from, or being differently located on the apparatus from, the workpieces already measured; the method comprising, for each such different series:
measuring an artefact, the artefact being one of the nominally identical workpieces of that series, or having features the size and shape of which approximate such a workpiece of that series;
obtaining calibration values for the artefact, from a source external to said measuring apparatus;
comparing the calibration values with the measurement of the artefact, to produce one or more correction values; and
using said correction values to further populate said error map or lookup table or recalculate said error function.

6. A method according to claim 5, in which the error map or look-up table or error function is used to correct the measurement of subsequent workpieces which are different from those of said first and further series of workpieces or which are differently located on the apparatus.

7. A method according to claim 5, in which measurements on the first and further series of workpieces take place at the same temperature, to within a predetermined tolerance, so that the error map, lookup table or function relates to that temperature.

8. A method according to claim 1, wherein a respective error map or lookup table or function is produced for each of two or more temperatures at which measurements of the calibrated workpiece take place.

9. A method according to claim 8, wherein the temperature of the measurement of the second workpiece is determined, and then the measurement is corrected using an error map, lookup table or function which corresponds to that temperature to within a predetermined tolerance.

10. A method according to claim 8, wherein the temperature of the measurement of the second workpiece is determined, and then the measurement is corrected by interpolation between or extrapolation from two or more of the error maps or lookup tables or functions.

11. A method according to claim 1, wherein the measurement of the production workpiece or artefact, from which the correction values are produced, takes place at two or more temperatures, and an error function is produced which has a term relating to the variation of measurement errors with the temperature at which the measurement takes place.

12. A method according to claim 11, wherein the temperature of the measurement of the second workpiece is determined, and then the measurement is corrected using said error function taking account of the temperature.

13. A method according to claim 1, wherein the measuring apparatus is a non-Cartesian coordinate measuring apparatus.

14. A method according to claim 1, wherein the measurements of the production workpiece or artefact include coordinate measurements of individual points on the surface of the workpiece or artefact.

15. A method according to claim 1, wherein the measurements of the production workpiece or artefact include measurements of dimensions of features of the workpiece or artefact.

16. Measuring apparatus configured to perform the method according to claim 1.

17. A program for a computer control of a measuring apparatus, which configures the apparatus to perform the method according to claim 1.
